(19) United States
(12) Patent Application Publication
(10) Pub. No.: US 2008/0167081 A1
(43) Pub. Date: Jul. 10, 2008

(54) Keyless touch-screen cellular telephone

(76) Inventor: U.P. Peter Eng, Palo Alto, CA (US)

Correspondence Address: U.P. Peter Eng., 4167 Hubbartt Drive, Palo Alto, CA, 94306, US

(21) Appl. No.: 11/652,225

(22) Filed: Jan. 10, 2007

(51) Int. Cl. H04M 1/00; G06F 3/041

(52) U.S. Cl. 455/566; 345/173

(57) ABSTRACT

A touch screen cellular telephone that includes a keyless touch screen display coupled to a wireless radio communication system contained therein. The touch screen display includes a plurality of touch screen contact areas for activation and non-active touch screen areas for display, wherein the touch screen display provides icon images for a keypad having a plurality of telephone keys, and wherein the contact areas for activation are activated without the assistance of physical keys.

### FIELD OF THE INVENTION

The present invention is generally directed to portable communication devices. More particularly, the invention relates to radio communication devices such as cellular telephones with keyless touch screen displays.

### BACKGROUND OF THE INVENTION

Radio communication devices today provide a wide variety of radio communication services such as two-way radio, radiotelephone service, and cellular phone service. Additionally, wireless data communication services are also available such as wireless fax (fax), electronic mail (e-mail), and short message service. These services are generally packaged individually into a single radio communication service device, such as a traditional radiotelephone.

By packaging radio communication services as individual devices, a manufacturer can offer a portable or hand held radio communication device that is relatively easy to use. However, there is increasing pressure in the marketplace to provide multi-functional radio communication devices that offer more than one of the typical radio communication services. Attempting to combine such radio communication services into a single radio communication device often creates a cumbersome user interface that is undesired by potential customers. For example, a typical user interface includes a speaker, a microphone, a display and a data input device such as a keypad. For some radio communication services a small display and a small data input area is required. With respect to a portable radiotelephone, there is often a small display and a fixed data input keypad. On the other hand, a wireless data service such as e-mail requires extensive display of received messages as well as substantial user data input from either a pen-based system or a keyboard. In certain applications where a manufacturer was to provide an integrated product that combined a radiotelephone and a data exchange service such as e-mail, a relatively simple user interface for the basic radiotelephone service would be however lost amidst the more complex user interface required for an e-mail service.

With the ever increasing popularity of portable electronic devices, such as cordless telephones and personal organizers, a higher priority is also being placed upon designing these devices in lightweight and compact forms that are readily portable. While a user may enjoy the portability of these devices, it may be necessary to carry several devices at the same time in order to support two way voice communication and data communication. Having to carry separate devices for a cordless telephone and personal organizer can be cumbersome for the user. Furthermore, these devices typically require separate chargers, and the disarray often associated with having multiple devices and adapters can become quite inconvenient to the user.

Additionally, interfaces for radio communications vary greatly between different manufacturers. Users often become accustomed to the location of certain keys or buttons on interfaces over a period of continued operation. Single-hand operation is often desired or achieved after repeated use of these devices in a manner often referred to as “rodeo-style” which predominantly relies on thumb dexterity. For example, a cell phone includes a fixed keypad with keys associated for various numbers and functions at predefined locations on the interface. But a user may be forced to adapt to the form factor decided by the manufacturer for the keys which are not particularly familiar or comfortable. Individuals with relatively smaller hands for example may have difficulty reaching keys located at far-reaching locations on the key interface. At the same time, persons with relatively long fingers may find it difficult to press buttons that are too close to their palms.

It would be therefore advantageous to provide integrated, portable data and voice communication devices having user surfaces that are more familiar and adaptable.

### SUMMARY OF THE INVENTION

The invention provides wireless communication devices with a touch screen graphical user interface. A variety of portable wireless devices including cellular telephones may be operated without mechanical keys. Many of the advancements in touch screen technology in the area of palm computing may be applied to the invention.

The integration of multiple wireless devices is supported by the invention by allowing operators to configure control keypad and display areas. Rather than being subjected to the form factors adopted by manufacturers in the location, size and layout of physical keys, an operator may select a preferred layout. Instead of competing for the available space on a wireless device, the customer may simply choose a desired proportion of a viewing area dedicated to both the control and information display functions. A single, relatively large touch screen may be divided into active regions for data entry and may also include relatively non-active regions for display. These areas within the touch screen display may be reconfigured during different modes of operation for the portable device.

Other objects and advantages of the invention will become apparent upon further consideration of the specification and drawings. While the following description may contain many specific details describing particular embodiments of the invention, this should not be construed as limitations to the scope of the invention, but rather as an exemplification of preferable embodiments. For each aspect of the invention, many variations are possible as suggested herein that are known to those of ordinary skill in the art.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a perspective view of a keyless touch screen cellular telephone formed in accordance with the concepts of the invention.

FIG. 2 is a perspective view of the telephone shown in FIG. 1 that includes a graphical user interface shown with dashed lines.

FIGS. 3-4 are simplified views of a wireless communication device with a keyless touch screen interface that includes a series of keypad icons and a display region.

FIGS. 5-6 are front views of a simplified mobile communication device that includes a user-configurable touch screen interface with variable control and display configurations.

FIG. 7 is a simplified front view of a wireless device operating in a telephone directory mode with iconic representations of entries and navigational arrows.

FIGS. 8-10 are various touch screen interfaces that may be displayed when the wireless devices herein are in a non-telephone mode of operation.

### DETAILED DESCRIPTION OF THE INVENTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

The following detailed description sets forth various embodiments that incorporate different aspects of the invention. It will be further understood that the described features of the following embodiments may be considered individually or in combination with other aspects of the invention.

The wireless communications devices provided herein address the move of the industry towards integration of multiple wireless apparatus and tools. Whereas control and display elements for integrated wireless devices typically compete for available space on a unit, the single larger touch screens provided herein offer a desirable screen and keypad overlay that may be user-configurable. Because there are no physical keys or miniaturized screens that restrict the ability for a user to select a preferred interface, the devices herein provide customized graphical user interface (GUI) settings which may be applied for any wireless communication device that supports voice, data or any other information that may be transmitted wirelessly.

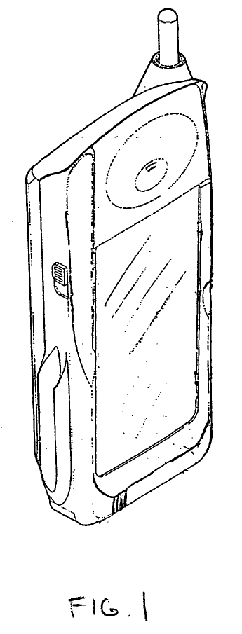

Referring now to FIG. 1, a keyless touch screen cellular telephone is provided in accordance with the invention. The wireless telephone includes a touch screen display that occupies a relatively large portion of the useable surface area of the unit. Upon first appearance, the unit may appear to be a cellular telephone having a sizable screen without any physical keys that many people are accustomed to seeing. However, as with most cellular phones, a speaker and microphone may be mounted at selected locations on the unit to support voice transmission and reception. A retractable antenna may be also included within at least a portion of the phone, and may be extended for improved reception during use. The unit may further include a power switch located on the side or along any other selected portion of the cell phone.

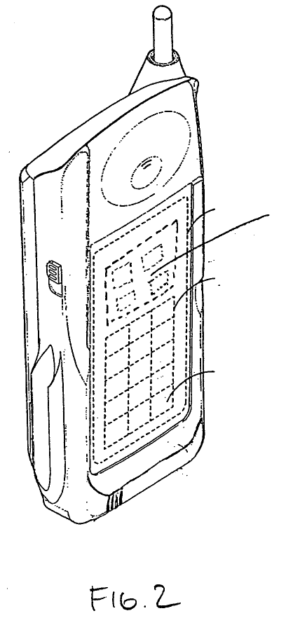

Upon power activation of the unit, as shown in phantom in FIG. 2, the touch screen may display an initial pop-up keypad and/or a main menu. The menu may be icon-based with pictorial representations of device operations as telephone, pager, organizer, PDA or browser. Any combination of text and illustrations may be also included within the menu. The activation areas on the touch screen may be also configured to display a selected visual control panel or keypad. Since a main menu is provided, there is no need for the flipping of doors or panels in order to switch between modes of operation as a telephone, organizer, pager, etc. Moreover, a flip-open door is not required to protect against the inadvertent pressing of keys because essentially no keys are physically protruding from the touch screen display. Accordingly, the displayed touch control menu provides a user interface with a variable form factor that supports one and two-way wireless communication.

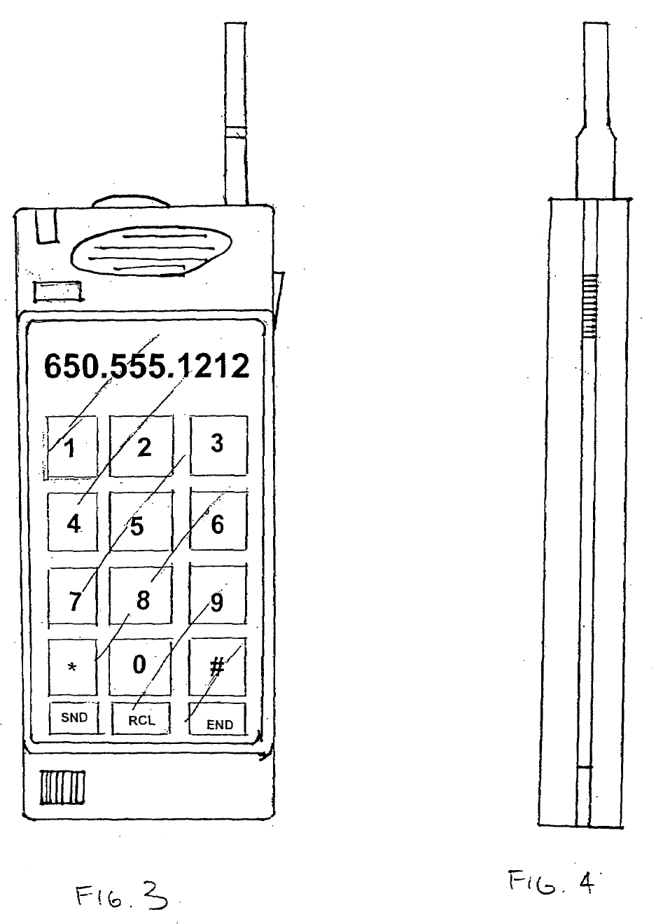

FIG. 3 illustrates yet another cellular telephone or wireless communication device formed in accordance with this aspect of the invention. The device may include common cell phone components including a speaker and microphone. connected to an internal radio communication system, an infrared (IR) port, an on/off button, and a stand-by light which may indicate the unit is turned on even when touch screen is temporarily blanked to conserve power. The cell phone may include a keyless touch screen display with familiar icons or images representing familiar numbers and telephone functions. The touch screen may include variable levels of sensitivity so users do not have to press relatively too long or too short. A keypad lock may be incorporated to prevent inadvertent entry or dialing of numbers or information. An audible tone or keyboard flash may further advise the user that a number or particular function has been entered while appearing or coming up in display region of touch screen. For example, the unit may be turned on by initially depressing the on/off switch to bring up a main menu. Upon selection by the user to begin operating in the telephone mode as described above, a conventional telephone keypad may be projected onto the touch screen display. Selected activation areas within the touch screen may initiate corresponding operations as is known by those of ordinary skill in the touch screen industry. A series of images or icons representing numbers “0” through “9” may appear on the touch screen. The desired number to be dialed may appear in a relatively non-active visual display region of the touch screen. When the number is entered and confirmed, the SND icon may be touched to continue the telephone call connection. The END icon may be pressed upon completion of the conversation, and the recall function may be also activated upon selection of the RCL key image to dial the previously dialed number(s) stored in memory. Contact with the touch screen display may be accomplished by simply using a finger to press the portion of the display overlying the displayed icon or image or by using a stylus accompanying the unit as shown in FIG. 4. The phone may be formed with a slot or groove, as with many palm style devices, so the stylus may be securely stored until needed. The stylus may include a tapered portion with grooves to allow easy deployment with slidable movement a finger or thumb alone. Other palm product accessories may be included with the wireless devices herein such as removable protective covers that protect the screen from damage when not in use. A protective cover or flap (not shown) may cover primarily the front touch screen portion of device or the entire device. It may be mounted or hinged to any side of unit to allow it to swing open, and may be formed of a rigid or flexible material or any shock-resistant plastic or leather to protect the touch screen display.

The touch screen displays provided herein include various degrees of back light illumination for contrast and better viewing. The recent advancements made in the industry to provide more clear and bright images on touch screen panels can be adapted for devices herein. The common green or blue background lighting provide adequate contrast with characters and icons on the touch screens. A single or multiple energy-efficient liquid crystal display (LCD) touch screen displays may be incorporated into the wireless devices herein from palm top computing devices (including the Palm III, V and VII series) and high-end remote controls for home entertainment systems (including Sony and Kenwood remote touch screen LCDs). Selected screens or portions of touch screen displays may be chosen for keypad or display operation, or for any other information exchange function. A variety of power management and consumption systems for touch screen displays and interfaces available today may be also selected to effect power-save modes which blank portions of or the entire screen until the touch screen is activated again by touch or contact. A screen saver or power down operation may commence after a selected period of inactivity, and the touch screen may even display a scrolling logo or decorative symbol unless power conservation is a principal concern.

The keypad and control display icons on the touch screen may disappear and blank out momentarily while speaking on the phone, and may reappear when touch activated. An incoming call or message may also reactivate the touch screen to inform the user of the call or page when the unit is activated in pager mode. In particular, the number or page received may flash across the touch screen and identify caller with caller ID and/or as person stored in personal directory of the unit. In some instances, pager text may be displayed by the wireless device when the unit is configured for operation in that designated mode. The user may in other instances direct incoming messages and calls to voicemail for later retrieval without being disturbed. New voice or text messages may be indicated on the touch screen by text or common message icons.

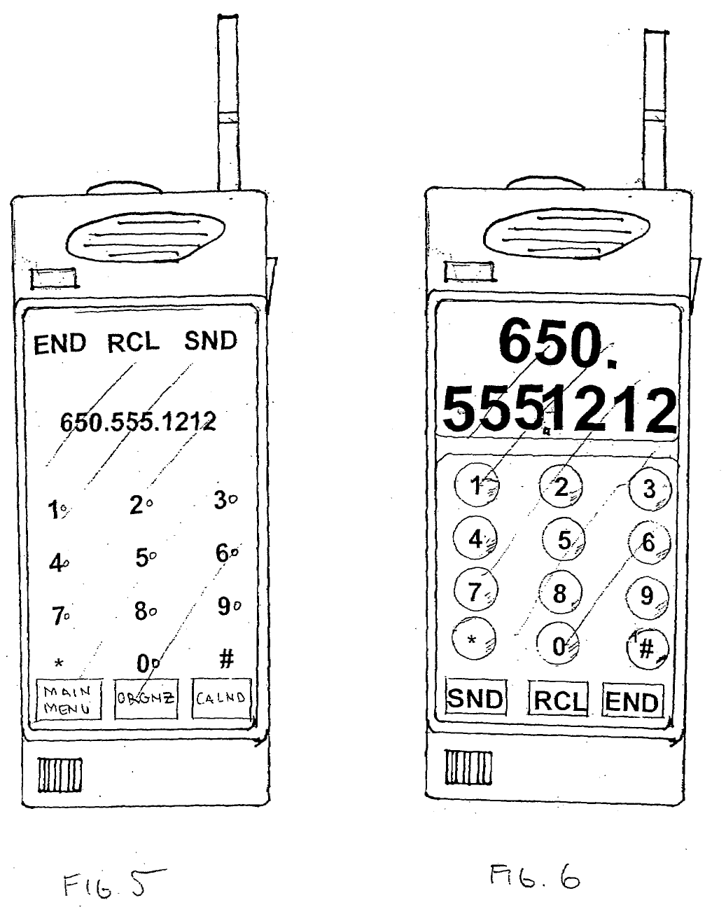

While the single large touch screen displays herein provide a wide degree of user interface customization, some preselected form factors may be desired for the specific location of a number keypad. For example, as shown in FIG. 5, a relatively simplified set of number icons may be projected on the touch screen display rather than in combination with square-bordered key images. A reasonable number of pixels or activation area segments corresponding to the particular number or function icon may be selected in accordance with accepted industry and practical standards. A user may thus select a desired location for particular icons on the touch screen display. At the same time, the touch screen display may include relatively fixed or predetermined interface sections. A number keypad may be fixed along a certain location and grid to correspond with overlying dimples or raised surfaces formed on the otherwise smooth or planar touch screen. These surfaces may assist during operation including single-hand operation or when numbers are entered without visual assistance while not looking at the interface. The number to be dialed may be displayed and verified for accuracy before initiating the call. An operator may thus feel the keypad despite the absence of mechanical keys.

FIG. 5 also depicts a touch screen user interface with variable form factor components. The relative font-size and location of displayed icons may be user selected. Similarly, the orientation of displays and keypad may be varied. The location of numbers and function key icons may be moved relatively higher or lower on the touch screen. While some users desire or are accustomed to the SND, RCL and END keys being located along the lower portion of the interface, others may prefer the icons or graphical “buttons” or “keys” to be located along the top section. The icons for controlling and moving between the various mode of operation for the unit, including the returning back to the Main Menu, the Organizer, the Calendar, etc., may be similarly positioned where desired and not fixed at a manufacturers preselected location. During all modes of unit operation, including the telephone mode, the primary main-menu may be accessed at any time and may be temporarily minimized along selected areas to increase display and activation space. When in other modes of operation, some visual and/or audible indication of an incoming telephone call may be provided. Additionally, the activation area or corresponding icon size may be varied to provide appropriately sized areas or big/small icons for pressing by operators with fat or skinny fingers on touch screen. The flexibility afforded by an adjustable touch screen interface provides more accurate operation as opposed to restrictive physical keys set by manufacturers that can be too small or large for some users. Accordingly, keypad icons may be larger with activation areas occupying more of the touch screen display with smaller display region of the display. The keypad icons may be alternatively smaller so that the displayed numbers on the touch screen are larger and easier to see if the user has poor eyesight or is operating the wireless device in poor lighting. Similarly, the END, RCL and SND keys may be located on left or right side portions of the touch screen, or along top or bottom portions of the screen depending on particular preferences or whether the operator is right or left handed, long or short fingered. The relative space to operate and view information on the device is therefore not fixed and user configurable thereby providing custom keypad arrangement.

As shown in FIG. 6, a number keypad may be selected with rounded key icons for the set of characters. Shading may be also included in the icon to provide a sense of a three-dimensionality to the pictoral image which may include or not include circle or square borders, or any other desired key icon image. The regions between the number and symbol icons may be darkened while the number icons are relatively brighter, or the key icons may be darkened among a blank background. The number keypad portion of the touch screen may be visually segmented from the display portion of the display portion of the screen, or physically separated with a border that divides one or more touch/visual screens from each other. While the display portion of the touch screen or pad offers a readout of the information inputted during a telephone operation, this region of the touch pad may be defined as an active region in other modes. For those who are visually impaired, the variable display settings provided herein offer relatively larger displayed numbers. The displayed text may occupy one, two or however many lines desired. While larger displays are provided at the expense of the keypad regions which are confined to a relatively smaller area, it is up to the user to select an acceptable trade-off between larger number or symbol icons for data entry or larger displays. In any event, the shared space between keypad and display provides customized viewing and operation based on ergonomic considerations and/or personal preferences.

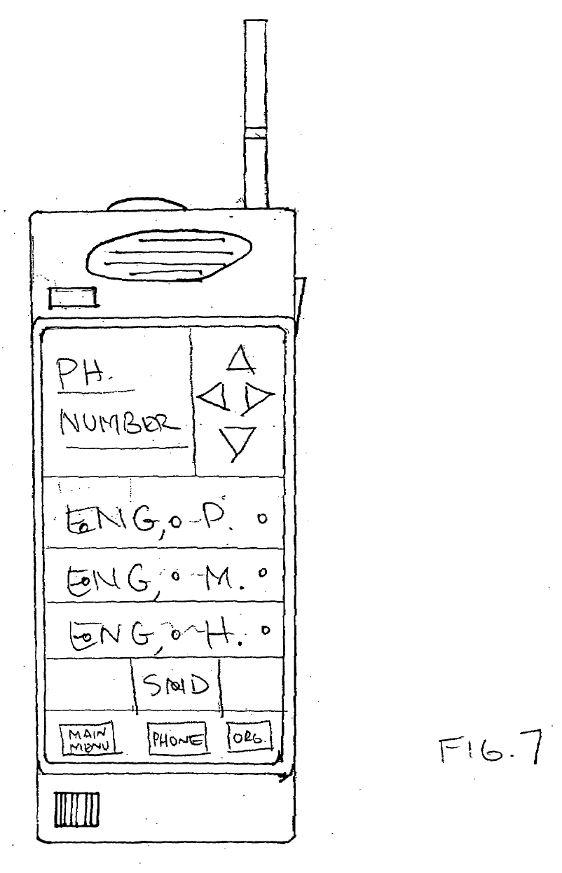

As described above, the cellular telephones herein may nonetheless incorporate predetermined form factors for a touch screen display. The touch screen may include dimples or raised surfaces as used in braille writings. While in telephone operating mode, the touch screen display with dimples may coincide with the numbers on the keypad. However, when switching modes to a telephone directory for example as shown in FIG. 7, the dimples may further delineate various entries that may be displayed in a series of pull-down menus. The spacing of the dimples and the menu selection icons may be preselected so entries may be made more readily when assisted by the sense of touch on a level-by-level basis. A series of directional arrow icons may be also provided to navigate around the user interfaces within the touch screen displays in any selected mode. At the same time, the touch screen interface during telephone mode operation may include an activation area to access the phone number directory or listing in order to place a call or even during a call when the other person on the line would like a number from the directory, organizer or any other information available from other modes of operation.

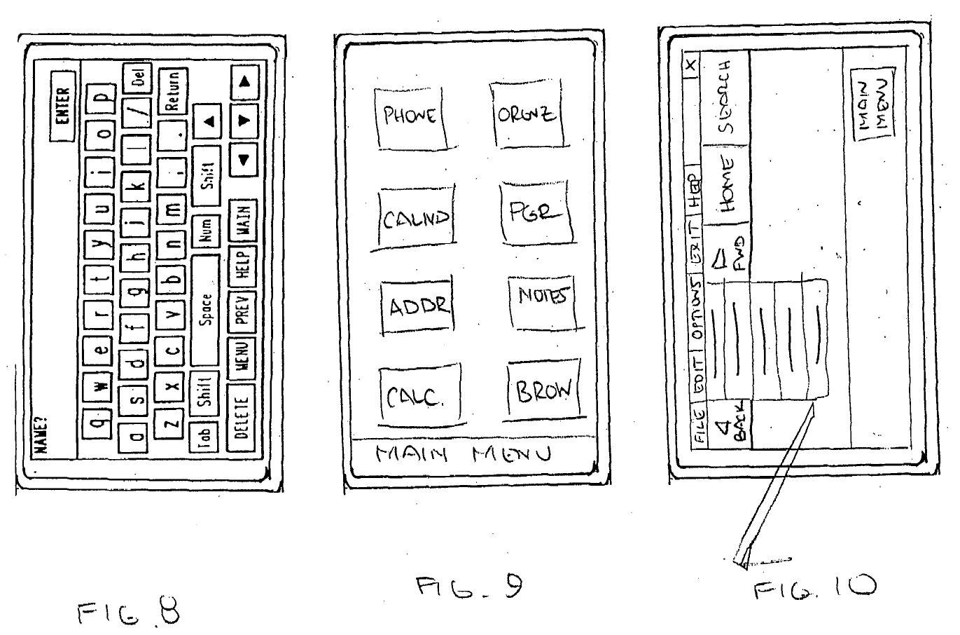

As with the telephone operation of the wireless devices provided herein, touch screen display or keypad icons may be shown in portrait or landscape views depending on desired mode of operation or personal preference. As shown in FIG. 8 (touch screen portion of device only), an iconic representation of an entire computer keyboard may be provided on the screen in landscape mode. Other combinations of alphanumeric keypads or keyboards may be also selected. When more left to right viewing area is desired in any of the devices herein, landscape mode is available. When a more top to bottom viewing area is preferred, the user may select portrait mode. The user is provided the opportunity to select the desired orientation and character size during operation of the device as an Organizer, Personal Digital Assistant (PDA), telephone or any other intended functionality. It shall be further understood that the hand-held computing devices or appliances herein may incorporate the same touch screen technology to perform a multitude of functions commonly found in devices like those described in the online literature and white paper as of the filing date of this patent application for Palm Computing Palm products at http:/www.palm.com and Handspring at http:/www.handspring.com, which are incorporated herein by reference in their entirety.

In FIG. 8, a touch screen keyboard may be projected onto the viewing area of the device. Because the unit is not in shown in a telephone operation mode, the number keypad and display for its respective functions are not currently illustrated. The entire surface area of the touch screen is thus available for larger and more detailed displays unlike current integrated wireless devices which include physical keys which occupy valuable space along the unit even when it is not being used a telephone. When a call is received while the operator is working in this displayed non-telephone mode, the screen may flash, ring or otherwise indicate an incoming call. A portion of the touch screen may even display the ID of the incoming caller when available (not shown). The user may return to the main menu and select telephone operation upon manually saving the information entered, or having the internal unit processor automatically store interrupted work while moving between various modes of operation.

A user may navigate between different modes of operation by returning to a main or previous menu provided on the touch screen display. For example, when working an Organizer mode with a iconic keyboard displayed, pressing menu can return the user back to the Main Menu as shown in FIG. 9. From that point, which may be the same splash screen that is projected when the unit is turned on, the user may enter into any other available mode that is supported by the unit. The operator may readily alternate between reviewing pager text or messages and making notes or any other supported function. As described above, some visual and/or audible indication may be provided to inform the operator of an incoming call or communication while working in a different mode of operation.

As with many wireless communications today, particularly cell phones, Internet access may be available with the devices provided herein. FIG. 10 is a palm touch screen display for a web browser (WAP and HTML) such as those used with the Motorola Timeport product line. It will be understood that functionality of these and other similar Internet-ready smartphones or wireless devices may be incorporated into the customized touch screen displays provided herein. Internet access today may be in many instances limited to modified or specific websites for wireless devices given the current data exchange or bit-rate constraints, but the devices herein may eventually operate as full web browser when wireless transmission and reception speeds increase to point where even video information may be received along with data and voice. Additionally, the interface may include icons or custom pull-down menu selections such as those found in the Windows CE platform. As with any of the pull-down menus for the devices herein, a user may configure the interface and partition the top bar Windows as desired to be viewed in landscape or portrait mode. The use of a stylus may be thus preferred when the entries within a selected touch screen display are relatively small thus making data entry with a finger more difficult.

The embodiments set forth above include only some examples of available touch screen display formats that may be selected for various modes of operation for the multi-function devices provided herein. Additional icons representative of other corresponding functionality may be supported by the touch screen displays and wireless devices herein which are well known in the art. For example, the configurable interfaces described in the following references may be readily applied to the concepts of the invention described herein: U.S. Pat. No. 5,848,356 (Method for Implementing Icons in a Radio Communication Device), U.S. Pat. No. 5,742,894 (Radio Communication Device Having a Movable Housing Element and Keypad Disposed Therein), U.S. Pat. No. 5,715,524 (Radio Communication Device With Movable Housing Element Control), and U.S. Pat. No. 5,584,054 (Communication Device Having a Movable Front Cover for Exposing a Touch Sensitive Display), which are incorporated by reference in their entirety herein with their respective cited references.

While the present invention has been described with reference to the aforementioned applications explained in detail above, these descriptions and illustrations of the preferred embodiments and methods are not meant to be construed in a limiting sense. It shall be understood that all aspects of the present invention are not limited to the specific depictions, configurations or relative proportions set forth herein which depend upon a variety of conditions and variables. Various modifications in form and detail of the various embodiments of the disclosed invention, as well as other variations of the present invention, will be apparent to a person skilled in the art upon reference to the present disclosure. It is therefore contemplated that the appended claims shall cover any such modifications, variations or equivalents of the described embodiments as falling within the true spirit and scope of the present invention.

What is claimed is:

1. A touch screen cellular telephone comprising:
a hand-held body formed with a front surface, wherein the body contains a wireless radio communication system;
a speaker and a microphone positioned at predefined locations along the hand-held body which are coupled to the wireless radio communication system for facilitating voice communication;
a keyless touch screen display coupled to the wireless radio communication system, wherein the touch screen display includes a touch screen contact area for user touch activation and a non-active touch screen area, wherein the contact areas of the touch screen includes a series of one ore more tactile surface enhancements overlaying one or more corresponding icon images displayed on the touch screen display.

2. A radio communication device comprising:
a device body containing radio circuitry disposed therein; and a keyless touch screen display coupled to the radio circuitry for displaying a virtual communication keypad having a plurality of user-configurable activation areas corresponding to a predefined array of keypad functions for entering input data, wherein the activations areas of the touch screen display may be located at user selected locations on the touch screen display.

3. The device as recited in claim 2 wherein the activation areas of the touch screen providing for input entry is approximately half the size when compared to the touch screen display.

4. The device as recited in claim 2 further comprising:
a processor disposed in the device body, wherein the processor is coupled to the touch screen display, and wherein the processor provides radio communication functions for the radio communication device in response to a user-activated mode menu.

5. The device as recited in claim 4, wherein the radio communication functions include telephone communication functions associated with the use of the plurality of telephone keys, the advanced radio communication functions including at least one of facsimile, electronic mail, and short-messaging service functions associated with use of the touch screen display.

6. The device as recited in claim 2, wherein the radio circuitry includes a processor coupled to the touch screen display, wherein the processor provides advanced radio communication functions in response to applied pressure to activations areas within the display.

7. The device as recited in claim 2, wherein the activation areas includes a touch screen portion for receiving handwritten data for display on the display screen in response to pressure applied to the touch sensitive screen.

8. The device as recited in claim 2, further comprising a stylus for entering the handwritten data onto the display screen.

9. The device as recited in claim 8, wherein the device body includes a retaining groove for storing the stylus.

10. The device as recited in claim 2, wherein the portable communication device operates as a radiotelephone when a telephone activation area within the touch screen display is activated, and the communication device operates as a personal organizer when an organizer activation area within the touch screen display is activated.

11. The device as recited in claim 2, further comprising means for receiving radio signaling information when the touch screen display is not selected for operation of the device as a telephone.

12. The device as recited in claim 11 wherein the means for receiving signaling information includes an antenna coupled to the housing.

13. The device as recited in claim 2 wherein the touch screen display includes with a first keypad area and a second keypad area, wherein the first keypad area includes a plurality of touch sensitive activation areas, and wherein the second area includes a visual display of information in response to activation of the touch sensitive area.

14. A touch screen cellular telephone comprising:
a cellular phone body with a front face that contains a wireless communication system; and
a keyless touch screen positioned along the front face of the cellular telephone body coupled to the wireless communication system, wherein the touch screen includes a iconic display of a keypad for direct entry of cellular telephone information and commands without the assistance of physical keys.
